(19) United States
(12) Patent Application Publication
(10) Pub. No.: US 2025/0372913 A1
(43) Pub. Date: Dec. 4, 2025

(54) CONNECTOR MALE PLUG, CONNECTOR, AND ELECTRONIC DEVICE

(71) Applicant: Huawei Technologies Co., Ltd., Shenzhen (CN)

(72) Inventors: Wenkui Wu, Shenzhen (CN); Xiliang Shan, Shanghai (CN); Yulin You, Shanghai (CN); Zhiyue Guo, Shanghai (CN); Tien Chieh Su, Shanghai (CN)

(21) Appl. No.: 19/301,558

(22) Filed: Aug. 15, 2025

Related U.S. Application Data
(63) Continuation of application No. PCT/CN2024/072346, filed on Jan. 15, 2024.

(30) Foreign Application Priority Data
Feb. 17, 2023 (CN) 202310156568.1

(51) Int. Cl. H01R 13/502; H01R 12/71; H01R 13/05

(52) U.S. Cl. CPC H01R 13/502; H01R 12/716; H01R 13/05

(57) ABSTRACT

In accordance with an embodiment, a connector male plug includes: a base having a connection portion and a main body, wherein the connection portion comprises at least one limiting hole; a supporting member fastened to the connection portion, wherein the supporting member comprises at least one limiting portion, the at least one limiting portion fits with the at least one limiting hole, and a material of the base has a higher strength than a material of the supporting member; and two rows of first connection terminals fastened to the supporting member.

### CROSS-REFERENCE TO RELATED APPLICATIONS

This application is a continuation of International application No. PCT/CN2024/072346, filed on Jan. 15, 2024, which claims priority to Chinese Patent Application No. 202310156568.1, filed on Feb. 17, 2023. The disclosures of the aforementioned applications are hereby incorporated by reference in their entireties.

### TECHNICAL FIELD

This application relates to the field of electronic device technologies, and more specifically, to a connector male plug, a connector, and an electronic device.

### BACKGROUND

Electronic products have become indispensable articles in daily life of users. With rapid development of the electronic products, electronic devices have more functions and more powerful performance. Implementation of various functions in the electronic device depends on information exchange between functional modules. Currently, the functional modules are connected through a board to board (BTB) connector, to simplify a connection assembly process, improve connection reliability of the functional modules, and further save installation space inside the electronic device.

As the functional modules in the electronic device increase sharply, a quantity of BTB connectors that connect the functional modules also increases gradually. To install enough BTB connectors in limited space of the electronic device, a size of the BTB connector needs to be small. In addition, to meet increasing requirements of users for miniaturization and thinness of electronic products, a stacking layout of the entire device is increasingly compact, and operational space for BTB assembly and mating is increasingly limited.

However, a decrease in the size of the BTB connector may cause a decrease in overall strength of the BTB connector. Consequently, in a process of assembling the electronic device, the BTB connector is easily damaged, and a problem such as poor contact is caused, severely affecting a product yield rate of the electronic device. Therefore, how to ensure the strength of the BTB connector is an urgent problem to be resolved.

### SUMMARY

This application provides a connector male plug, a connector, and an electronic device, to ensure strength of a BTB connector.

According to a first aspect, a connector male plug is provided, including: a base, where the base includes a connection portion and a supporting portion, and the connection portion includes at least one limiting hole; a supporting member, fastened to the connection portion, where the supporting member includes at least one limiting portion, the at least one limiting portion fits with the at least one limiting hole, and strength of a material of the base is higher than strength of a material of the supporting member; and two rows of first connection terminals, where the two rows of first connection terminals are fastened to the supporting member.

In a possible implementation, the limiting hole is a closed hole. In another possible implementation, the limiting hole is an open hole. In other words, at least some limiting holes are notches.

In the foregoing solution, the strength of the material of the base is higher than the strength of the material of the supporting member. Therefore, compared with a conventional connector male plug, the connector male plug can be improved in strength through the base. As sizes of BTB connectors continuously decrease, the base can still ensure strength of the connector male plug, to ensure a high yield rate of electronic products. The first connection terminal is embedded in the first through hole and is not in contact with the first through hole, to improve strength and safety performance of the components in a thinner structure.

With reference to the first aspect, in some implementations of the first aspect, the material of the base is metal or ceramic, and the material of the supporting member is plastic.

With reference to the first aspect, in some implementations of the first aspect, the base further includes an embedding portion, and the embedding portion is a bending structure that is connected to a main body of the base and that faces the supporting member. The embedding portion is fastened to the supporting member, and is partially or completely hidden in the supporting member.

With reference to the first aspect, in some implementations of the first aspect, the connector male plug has a first end and a second end. The embedding portion extends in a direction from the first end to the second end, and a bending reference line of the embedding portion passes through or does not pass through all or some of the at least one limiting hole.

With reference to the first aspect, in some implementations of the first aspect, the supporting member further includes a row of first limiting portions and a row of second limiting portions that are disposed opposite to each other. One row of first connection terminals in the two rows of first connection terminals are fastened to the row of first limiting portions, and the other row of first connection terminals in the two rows of first connection terminals are fastened to the row of second limiting portions.

With reference to the first aspect, in some implementations of the first aspect, each first connection terminal in the two rows of first connection terminals includes two ends, one of the two ends is embedded in the limiting hole, the other of the two ends is a first pin, and the first pin is configured to electrically connect to another circuit.

With reference to the first aspect, in some implementations of the first aspect, a main body of each first connection terminal is in a U-shaped structure, and an opening of the U-shaped structure faces the supporting member. Surfaces that are of the two rows of first connection terminals and that are in contact with the supporting member include a surface opposite to a surface on which the base is in contact with the supporting member. The embedding portion of the base is fastened in openings of the two rows of first connection terminals, and is not in contact with the two rows of first connection terminals.

With reference to the first aspect, in some implementations of the first aspect, the supporting member is in an annular structure, and the supporting member further includes mounting portions that are disposed opposite to each other in a second direction. The connector male plug further includes male plug end fittings, and the male plug end fittings are disposed opposite to each other in the second direction and are fastened to the mounting portions.

With reference to the first aspect, in some implementations of the first aspect, the base further includes a positioning portion, and the positioning portion is configured to position the base when the connector male plug is manufactured.

With reference to the first aspect, in some implementations of the first aspect, a height of the base is less than or equal to 0.11 mm.

Therefore, a height of the connector male plug decreases when strength of the connector male plug is ensured. In addition, a height of the BTB connector decreases when strength of the connector is ensured.

According to a second aspect, a connector is provided, including the connector male plug according to the first aspect and a connector female receptacle. The connector female receptacle includes a first housing and two rows of second connection terminals. The first housing includes an accommodating cavity and a middle island, the middle island is a protrusion structure disposed on a bottom wall of the accommodating cavity, and the middle island extends in the second direction. The two rows of second connection terminals are fastened to the first housing and are respectively located on two sides of the middle island, and the two rows of second connection terminals are arranged in the second direction. The supporting member of the connector male plug is plugged into the accommodating cavity of the first housing of the connector female receptacle, one row of first connection terminals are in one-to-one conductive contact with one row of second connection terminals that are in the two rows of second connection terminals and that are disposed on a same side as the row of first connection terminals, and the other row of first connection terminals are in one-to-one conductive contact with the other row of second connection terminals that are in the two rows of second connection terminals and that are disposed on a same side as the other row of first connection terminals.

With reference to the second aspect, in some implementations of the second aspect, a first contact portion of the first connection terminal and a second contact portion of the second connection terminal are in contact with each other, and a third contact portion of the first connection terminal and a fourth contact portion of the second connection terminal are in contact with each other. The first contact portion is disposed opposite to the third contact portion, and the second contact portion is disposed opposite to the fourth contact portion. When assembling of the connector male plug and the connector female receptacle is started, a contact point at which the first contact portion and the second contact portion are in contact with each other is a first contact point. When assembling of the connector male plug and the connector female receptacle is completed, a contact point at which the first contact portion and the second contact portion are in contact with each other is a second contact point. A distance between the first contact point and the second contact point is greater than or equal to a first threshold.

With reference to the second aspect, in some implementations of the second aspect, the connector female receptacle further includes a middle island fitting. The middle island fitting is disposed at an end portion of the middle island, and the middle island fitting includes a fastened first supporting end, a fastened second supporting end, and an elastic arm. The first supporting end covers each surface of the end portion of the middle island, and the elastic arm is connected to the first supporting end through the second supporting end. There are two elastic arms, the two elastic arms are respectively disposed on two opposite sides of the first supporting end, the elastic arms have contact points, and the contact points of the two elastic arms are disposed opposite to each other.

With reference to the second aspect, in some implementations of the second aspect, a height of the connector female receptacle is less than or equal to 0.5 mm.

With reference to the second aspect, in some implementations of the second aspect, a height of the connector is less than or equal to 0.5 mm.

According to a third aspect, an electronic device is provided, including a first circuit board, a second circuit board, and the connector according to the second aspect. The connector male plug is electrically connected to the first circuit board through the first connection terminals and the base, and the connector female receptacle is electrically connected to the second circuit board through the second connection terminals.

### BRIEF DESCRIPTION OF DRAWINGS

FIG. 1 is a diagram of a structure of a conventional connector female receptacle;

FIG. 2 is a diagram of a structure of a conventional connector male plug;

FIG. 3 is a diagram of a structure of a connector male plug according to an embodiment of this application;

FIG. 4 is a diagram of a structure of a base other than a supporting member in the connector male plug in FIG. 3;

FIG. 5 is a diagram of a structure of a supporting member in the connector male plug in FIG. 3;

FIG. 6 is a diagram of a structure of a first connection terminal and an end fitting in the connector male plug in FIG. 3;

FIG. 7(a) to FIG. 7(c) are a diagram of an example structure of a base in the connector male plug in FIG. 3;

FIG. 8(a) to FIG. 8(c) are a diagram of a plurality of example structures of the connector male plug in FIG. 3;

FIG. 9 is an A-A stepped sectional view of the connector male plug in FIG. 3;

FIG. 10 is a diagram of a structure of a connector female receptacle according to an embodiment of this application;

FIG. 11 is a diagram of a structure of a middle island fitting according to an embodiment of this application;

FIG. 12 is a diagram of a plugging process of a connector male plug and a connector female receptacle according to an embodiment of this application;

FIG. 13 is a diagram of a structure of a connector according to an embodiment of this application; and

FIG. 14 is a B-B sectional view of the connector in FIG. 13.

### DETAILED DESCRIPTION OF ILLUSTRATIVE EMBODIMENTS

The following describes technical solutions of this application with reference to the accompanying drawings.

With rapid development of electronic devices, an electronic device provides a user with more functions, for example, photographing, video recording, and music playing of a mobile phone. This means that a quantity of functional modules in the electronic device increases. Implementation of various functions in the electronic device depends on information exchange between the functional modules. Currently, the functional modules are connected through a board to board (BTB) connector, to simplify a connection assembly process, improve connection reliability of the functional modules, and further save installation space inside the electronic device.

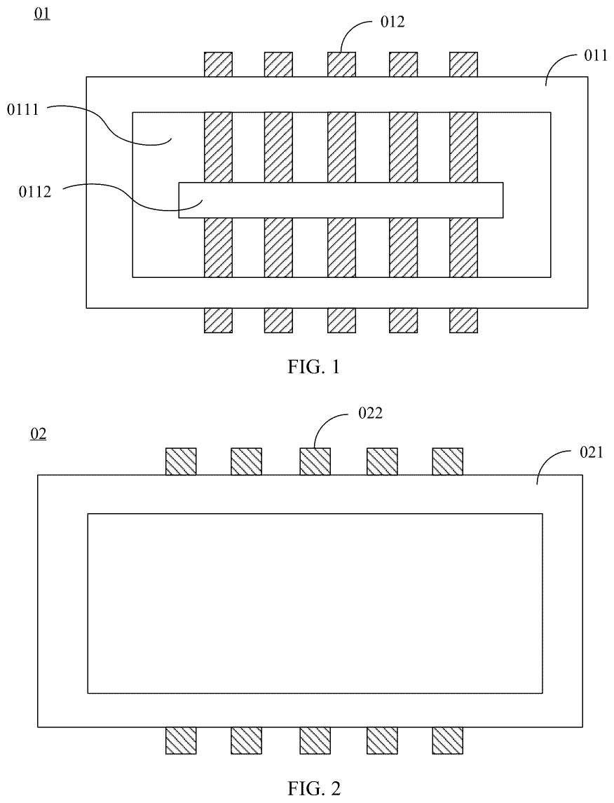

A conventional BTB connector includes a connector male plug and a connector female receptacle that can be connected through signals. FIG. 1 is a diagram of a structure of a conventional connector female receptacle. The connector female receptacle 01 may include a supporting member 011, an accommodating cavity 0111 of the supporting member 011 has a middle island 0112, and a part of a connection terminal 012 of the connector female receptacle 01 is hidden in the middle island 0112. The supporting member 011 is usually formed through plastic injection molding, and can fasten connection terminals 012 of the connector female receptacle 01 while protecting the connection terminals 012.

Similarly, FIG. 2 is a diagram of a structure of a conventional connector male plug. The connector male plug 02 may include a second housing 021, and a part of a connection terminal 022 of the connector male plug 02 is hidden in the second housing 021. The second housing 021 is usually formed through plastic injection molding, and is mainly configured to fasten connection terminals 022.

When the BTB connector is used for connecting functional modules, the connector male plug 02 in FIG. 2 may be connected to a circuit board of one functional module through signals, and the connector female receptacle 01 in FIG. 1 may be connected to a circuit board of the other functional module through signals. Therefore, the connector male plug 02 is plugged into the connector female receptacle 01, and the connection terminals 022 of the connector male plug 02 are electrically connected to the connection terminals 012 of the connector female receptacle 01, to implement signal transmission between the two functional modules. In addition, in a process in which the connector male plug 02 of the BTB connector is plugged into the connector female receptacle 01, the middle island 0112 of the supporting member 011 may support the connector male plug 02, and also limit a depth at which the connector male plug 02 is plugged into the supporting member 011 of the connector female receptacle 01, so that the connector male plug 02 is plugged in position, to implement effective contact between the connection terminals 022 of the connector male plug 02 and the connection terminals 012 of the connector female receptacle 01.

As the functional modules in the electronic device increase sharply, a quantity of BTB connectors that connect the functional modules also increases gradually. To install enough BTB connectors in limited space of the electronic device, a size of the BTB connector needs to be small.

However, a decrease in a size of the BTB connector may cause a decrease in overall strength of the BTB connector. Therefore, in an assembly process of the connector male plug 02 and the connector female receptacle 01 of the BTB connector, a connection terminal in the BTB connector is prone to tilt, and a problem such as poor contact is caused, severely affecting a product yield rate of electronic device.

In addition, in a process of using the BTB connector, the connector male plug 02 is usually plugged into the connector female receptacle 01. Therefore, the connector female receptacle 01 is used as a main component for bearing plugging force, and structural reliability of the connector female receptacle 01 has a significant impact on structural strength of the entire BTB connector.

Based on this, this application provides a connector male plug, a connector, and an electronic device, to implement high strength and high reliability, and also reduce a mating height and implement thinness of an entire device. In addition, the connector provided in this application may be used in various electronic devices related to an assembly connection solution, for example, including but not limited to a mobile phone, a wearable electronic device, a notebook computer, an all-in-one machine, a palmtop computer (personal digital assistant, PDA), a mobile carrier, or an intelligent driving device. The assembly connection solution includes but is not limited to a solution of detachable connection between a main board and an assembly such as a camera, a screen, or a battery. Specifically, the mobile carrier in this application may include a land vehicle, a watercraft, an aircraft, an industrial device, an agricultural device, an entertainment device, or the like. For example, the mobile carrier may be a vehicle. The vehicle is a vehicle in a broad sense, and may be a transportation means (for example, a commercial vehicle, a passenger vehicle, a motorcycle, a flight vehicle, or a train), an industrial vehicle (for example, a pallet truck, a trailer, or a tractor), an engineering vehicle (for example, an excavator, a bulldozer, or a crane), an agricultural device (for example, a lawn mower or a harvester), a recreation device, or a toy vehicle. A type of the vehicle is not specifically limited in embodiments of this application. For another example, the mobile carrier may be a transportation means, for example, an airplane or a ship.

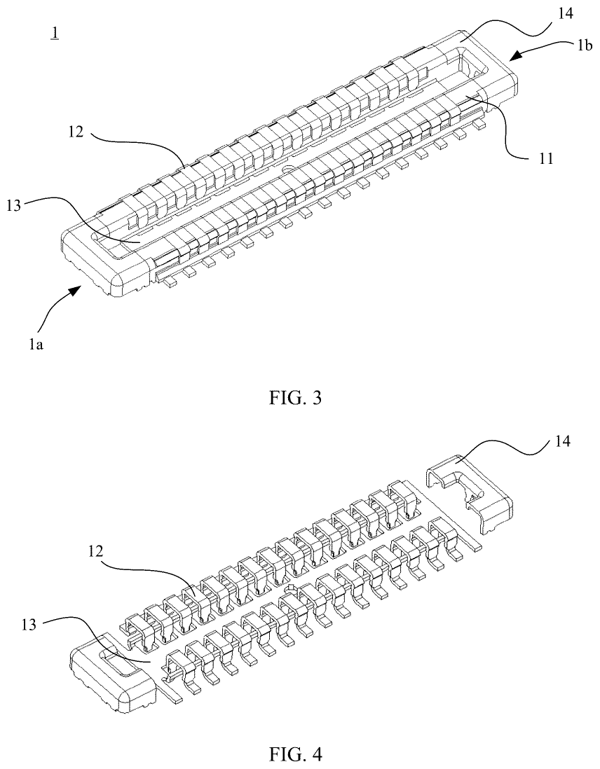

FIG. 3 is a diagram of a structure of a connector male plug 1 according to an embodiment of this application. As shown in FIG. 3, the connector male plug 1 may include a supporting member 11, two rows of first connection terminals 12, and a base 13.

The base 13 includes a connection portion and a supporting portion, and the connection portion includes at least one limiting hole. In a possible implementation, the limiting hole is a closed hole. In another possible implementation, the limiting hole is an open hole. In other words, at least some limiting holes are notches. The limiting hole herein may be a square hole, a circular hole, or a hole in another shape. This is not limited in this application. The at least one limiting hole herein may be arranged according to a specific rule, or may be arranged randomly. This is not limited in this application. Optionally, the base 13 further includes an embedding portion, and the embedding portion is a bending structure that is connected to a main body of the base and that faces the supporting member 11. The embedding portion is fastened to the supporting member 11, and is partially or completely hidden in the supporting member. The connector male plug 1 has a first end 1a and a second end 1b. The embedding portion extends in a direction from the first end 1a to the second end 1b, and a bending reference line of the embedding portion passes through or does not pass through all or some of the at least one limiting hole. Optionally, the base 13 further includes a positioning portion, and the positioning portion is configured to position the base 13 when the connector male plug 1 is manufactured.

The supporting member 11 is fastened to the connection portion of the base 13. The supporting member 11 includes at least one limiting portion, and the at least one limiting portion of the supporting member 11 fits with the at least one limiting hole of the base 13. Strength of a material of the base is higher than strength of a material of the supporting member. For example, the material of the base is metal or ceramic, and the material of the supporting member is plastic.

The two rows of first connection terminals 12 are fastened to the supporting member 11. A main body of each first connection terminal 12 is in a U-shaped structure, and an opening of the U-shaped structure faces the supporting member 11. Surfaces that are of the two rows of first connection terminals 12 and that are in contact with the supporting member 11 include a surface opposite to a first surface, and the first surface is a surface on which the base 13 is in contact with the supporting member 11. The embedding portion of the base 13 is fastened in openings of the two rows of first connection terminals 12, and is not in contact with the two rows of first connection terminals 12.

Optionally, the connector male plug 1 further includes a male plug end fitting 14. The connector male plug 1 has the first end 1a and the second end 1b that are opposite to each other. A direction perpendicular to the direction from the first end 1a to the second end 1b is a first direction, and a direction parallel to the direction from the first end 1a to the second end 1b is a second direction. The first direction is perpendicular to the second direction.

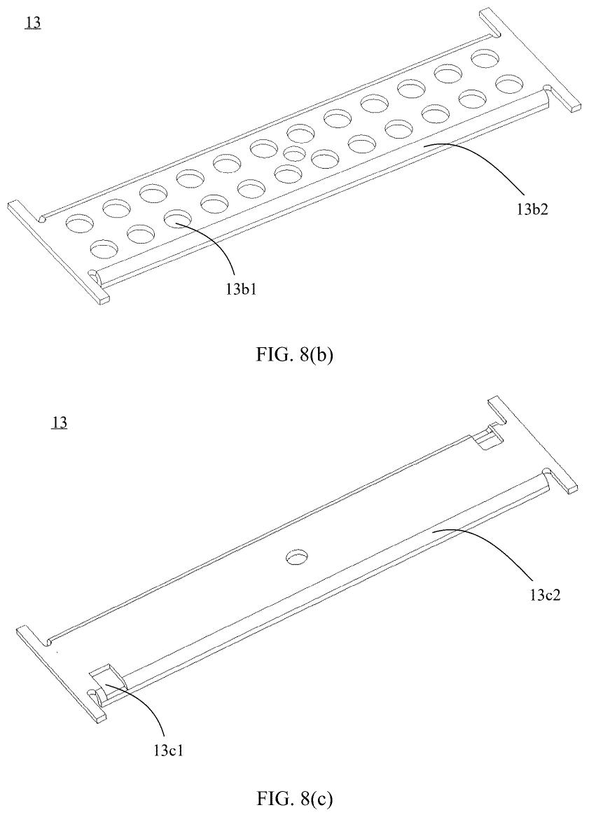

The following provides several specific examples of the base 13 with reference to FIG. 8(a) to FIG. 8(c).

In a first specific example of the base 13, as shown in FIG. 8(a), two rows of first through holes 13a2 are used as an example of the limiting hole, and two rows of bending structures 13a1 are used as an example of the embedding portion. It can be learned from the figure that one row of first through holes 13a2 and the other row of first through holes 13a2 in the two rows of first through holes 13a2 are provided opposite to each other in the first direction, and are arranged in the second direction. The first through holes 13a2 are open through holes, with openings facing a direction away from the base 13. The bending structures 13a1 extend from the first end 1a to the second end 1b. A bending reference line of the bending structures 13a1 located on a same side of the base 13 passes through the first through holes 13a2.

In a second specific example of the base 13, as shown in FIG. 8(b), two rows of first through holes 13b1 are used as an example of the limiting hole, and two rows of bending structures 13b2 that are disposed opposite to each other are used as an example of the embedding portion. It can be learned from the figure that one row of first through holes 13b1 and the other row of first through holes 13b1 in the two rows of first through holes 13b1 are provided opposite to each other in the first direction, and are arranged in the second direction. The first through holes 13b1 are closed round holes. The bending structures 13b2 extend from the first end 1a to the second end 1b. A bending reference line of the bending structure 13b2 located on a same side of the base 13 does not pass through the first through holes 13b1.

In a third specific example of the base 13, as shown in FIG. 8(c), two first through holes 13c1 are used as an example of the limiting hole, and two rows of bending structures 13c2 that are disposed opposite to each other are used as an example of the embedding portion. It can be learned from the figure that the two first through holes 13c1 are provided opposite to each other along a diagonal line of the base 13. The first through holes 13c1 are closed square holes. The bending structures 1302 extend from the first end 1a to the second end 1b. A bending reference line of the bending structure 13c2 located on a same side of the base 13 passes through the first through hole 13c1.

The following provides a specific example of the connector male plug 1.

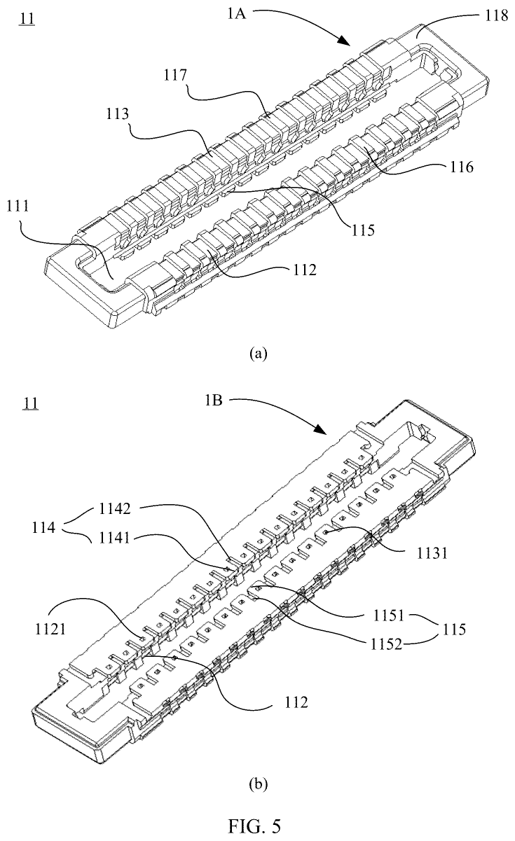

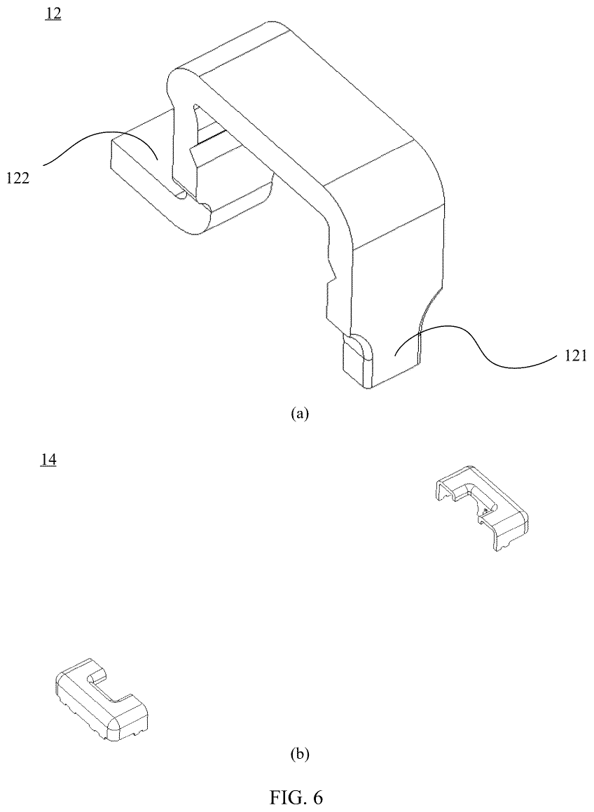

FIG. 5 is a diagram of a structure of the supporting member 11 in the connector male plug 1 in FIG. 3. The supporting member 11 has a first surface 1A and a second surface 1B that are opposite to each other. A top surface of the supporting member 11 shown in (a) in FIG. 5 is the first surface 1A, and a top surface of the supporting member 11 shown in (b) in FIG. 5 is the second surface 1B. As shown in (a) in FIG. 5, the supporting member 11 includes a row of first limiting portions 112 and a row of second limiting portions 113 that are disposed opposite to each other in the first direction. In the first direction, there is a slot between the row of first limiting portions and the row of second limiting portions. The row of first limiting portions 112 and the row of second limiting portions 113 are both arranged in the second direction. The supporting member 11 is in an annular structure, and the supporting member 11 further includes mounting portions 118 disposed opposite to each other in the second direction. Refer to FIG. 5. The supporting member 11 in the annular structure includes a second through hole 111, and the slot between the row of first limiting portions and the row of second limiting portions may be the second through hole 111. As shown in (b) in FIG. 5, the supporting member 11 may further include a row of third limiting portions 114 and a row of fourth limiting portions 115. The row of third limiting portions 114 and the row of fourth limiting portions 115 are both arranged in the second direction. Specifically, each third limiting portion 114 includes a fourth embedding portion 1141 and a first groove 1142, and each fourth limiting portion 115 includes a fifth embedding portion 1151 and a second groove 1152.

The supporting member 11 may be, but is not limited to, injection molded with a plastic material such as plastic, to effectively simplify a processing technology of the supporting member 11 and also improve integration of the supporting member 11. This facilitates a miniaturization design of the connector male plug 1.

(a) in FIG. 6 is a diagram of a structure of the first connection terminal 12 in the connector male plug 1 in FIG. 3. The first connection terminal 12 includes two ends. One end of the two ends is a third embedding portion 121, and the other end is a first pin 122. In the connector male plug 1, the first pin 122 is exposed outside the supporting member 11, to fasten the first pin 122 to another circuit, for example, to connect the first pin 122 and a pad on a circuit board. A main body of the first connection terminal 12 is in a U-shaped structure.

Refer to FIG. 3 and FIG. 5. One row of first connection terminals 12 are fastened to the row of first limiting portions 112, and the other row of first connection terminals 12 are fastened to the row of second limiting portions 113. Therefore, with reference to FIG. 3, it can be understood that the second through hole 111 of the supporting member 11 is provided between the two rows of first connection terminals 12.

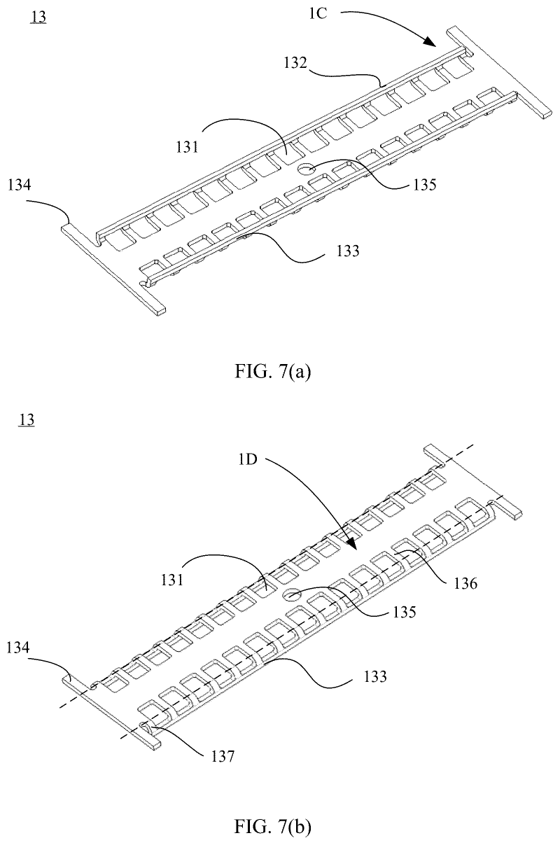

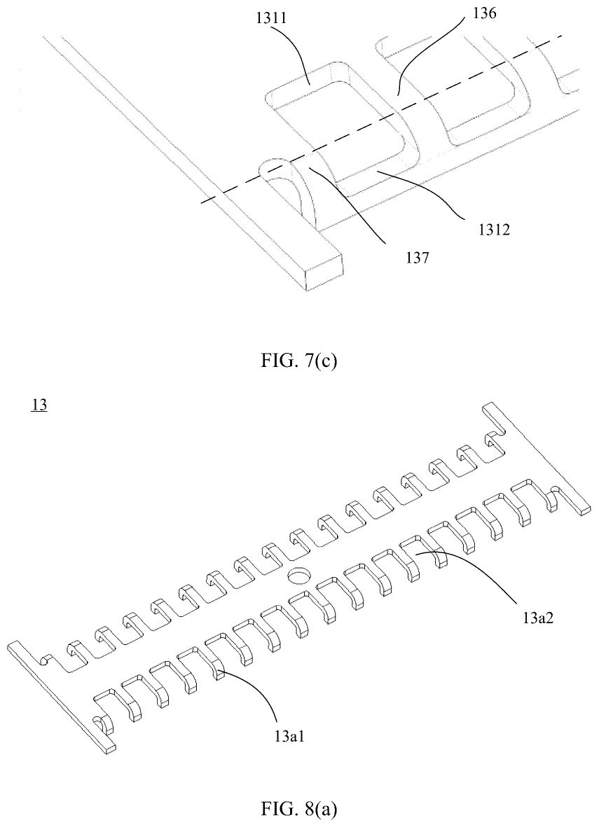

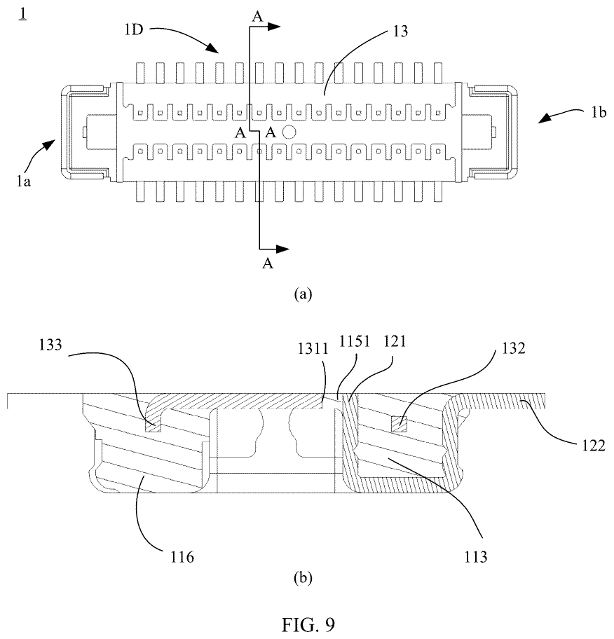

The following provides a fourth specific example of the base 13. The base 13 includes a third surface 1C and a fourth surface 1D that are opposite to each other. A top surface of the base 13 shown in FIG. 3 to FIG. 7(a) to FIG. 7(c) is the third surface 1C, and a bottom surface of the base 13 shown in FIG. 3 to FIG. 7(a) to FIG. 7(c) is the fourth surface 1D. A top surface of the base 13 shown in (a) in FIG. 9 is the fourth surface 1D. FIG. 7(a) to FIG. 7(c) are diagrams of a structure of the base in the connector male plug 1 in FIG. 3. As shown in FIG. 7(a), the base 13 may include two rows of first through holes 131, and each row of first through holes in the two rows of first through holes 131 are arranged in the second direction. The base 13 further includes a first embedding portion 132 and a second embedding portion 133 that are disposed opposite to each other in the first direction. Both the first embedding portion 132 and the second embedding portion 133 extend in the second direction. The first embedding portion 132 and the second embedding portion 133 are bending structures that are connected to the main body of the base 13 and that are bent toward the supporting member 11. Specifically, as shown in FIG. 7(b), both dashed lines are bending reference lines, and a bending reference line of a bending structure close to one row of first through holes 131 in the two rows of first through holes 131 passes through the row of first through holes 131. Every two first through holes 131 in each row of first through holes 131 are connected to each other through a first connection portion 136, and first through holes 131 at two ends of each row of first through holes 131 are respectively connected to the two ends of the base 13 through second connection portions 137. In addition, the connection portion 136 and the connection portion 137 are further configured to connect the main body of the base 13 to the first embedding portion 132, and connect the main body of the base 13 to the second embedding portion 133. Before the base 13 is bent along the bending reference line, two side surfaces that are opposite to each other in the first direction in four side surfaces of the first through hole 131 are a first side surface 1311 and a second side surface 1312, and the two side surfaces are parallel to each other. In the two side surfaces, a side surface that is farther away from an edge that is of the base 13 and that extends in the second direction is the first side surface 1311, and a side surface that is closer to the edge that is of the base 13 and that extends in the second direction is the second side surface 1312. After the base 13 is bent along the bending reference line, as shown in FIG. 7(c), a dashed line is a bending reference line, and the first side surface 1311 and the second side surface 1312 are no longer parallel to each other. For example, the first embedding portion 132 and the second embedding portion 133 are bent by 90 degrees relative to the main body of the base 13. In this case, the first side surface 1311 and the second side surface 1312 are perpendicular to each other. The main body of the base 13 and the bending structure may be integrally formed, or the first embedding portion 132 and the second embedding portion 133 may be soldered to the main body of the base 13. The base 13 may further include a second pin 134. The second pin 134 is fastened to another circuit. For example, the second pin 134 is soldered to a pad on a circuit board.

The base 13 is fastened to the supporting member 11. For example, refer to FIG. 3 and FIG. 5. The third surface 1C of the base 13 is fastened to the second surface 1B of the supporting member 11. Specifically, one row of first through holes 131 are fastened to the third limiting portions 114, and the other row of first through holes 131 are fastened to the fourth limiting portions 115. Further, the fourth embedding portions 1141 are fastened to one row of first through holes 131, and the fifth embedding portions 1151 are fastened to the other row of first through holes 131. A connection member between every two first through holes 131 in one row of first through holes 131 is fastened to the first groove 1142, and a connection member between every two first through holes 131 in the other row of first through holes 131 is fastened to the second groove 1152. The first embedding portion 132 and the second embedding portion 133 are fastened to the supporting member, and are partially or completely hidden in the supporting member.

Strength of the material of the base is higher than strength of the material of the supporting member. For example, the material of the base is metal, ceramic, or a fiber reinforced ceramic matrix composite, for example, steel, iron, silicon carbide, silicon nitride, or carbon fiber reinforced silicon nitride. The material of the supporting member is plastic. Therefore, compared with a conventional connector male plug, the connector male plug can be improved in strength through the base. As sizes of BTB connectors continuously decrease, the base can still ensure strength of the connector male plug, to ensure a high yield rate of electronic products.

Optionally, a thickness of the base is less than or equal to 0.11 mm. For example, the thickness of the base may be 0.11 mm, 0.1 mm, 0.09 mm, 0.08 mm, 0.07 mm, or 0.06 mm. Therefore, compared with the conventional connector male plug, the connector male plug can be improved in strength and decreased in height through the base, thereby improving product competitiveness in terms of thinness. In addition, for example, the thickness of the base 13 is 0.06 mm and the material of the base 13 is steel. Experiments show that side push strength of the connector male plug 1 is 35.7% higher than that of the conventional connector male plug and torsion strength is 18.5% higher than that of the conventional connector male plug. It may be understood that, after a male plug and a female receptacle of a conventional BTB connector are assembled, middle plastic of the connector male plug and middle island plastic of the connector female receptacle are in stop position. Therefore, a thickness of the middle plastic of the connector male plug affects a height of the connector. Therefore, a height of the connector male plug decreases when strength of the connector male plug is ensured. In addition, a height of the BTB connector decreases when strength of the connector is ensured.

Refer to FIG. 4. The third embedding portion 121 of each first connection terminal 12 is embedded into the first through hole 131 and is not in contact with the first through hole 131. In the second direction, a width of the third embedding portion 121 is less than a width of the main body of the first connection terminal 12. The third embedding portion 121 may be but is not limited to a structure shown in (a) in FIG. 6. The third embedding portion 121 of each first connection terminal 12 is fastened to the supporting member 11, and the supporting member 11 is fastened to the first through hole 131. It may be understood that the supporting member 11 is filled between the first through hole 131 and the third embedding portion 121, or the third embedding portion 121 is fastened to an inner wall of the first through hole 131 through the supporting member. Specifically, refer to FIG. 3 and FIG. 5. A row of first connection terminals 12 fastened to a row of first limiting portions 112 are used as an example. Each first limiting portion 112 corresponds to each third limiting portion 114, and the first limiting portion 112 includes a third through hole 1121. The third through hole passes through the third limiting portion 114, and the third embedding portion 121 of each first connection terminal 12 is embedded into the third through hole 1121. A row of first connection terminals 12 fastened to a row of second limiting portions 113 are used as an example. Each second limiting portion 113 corresponds to each fourth limiting portion 115, and the second limiting portion 113 includes a fourth through hole 1131. The fourth through hole 1131 passes through the fourth limiting portion 115, and the third embedding portion 121 of each first connection terminal 12 is embedded into the fourth through hole 1131. For example, on the basis of fastening the two rows of first connection terminals 12, the supporting member 11 may be obtained through an injection molding process, so that the supporting member 11 forms the third through hole 1121 and the fourth through hole 1131 that adapt to the third embedding portion 121.

With reference to (a) in FIG. 6 and FIG. 3, it can be learned that the main body of each first connection terminal 12 is in a U-shaped structure, and an opening of the U-shaped structure faces the supporting member 11. Refer to (b) in FIG. 9. The first connection terminal 12 is fastened to the first limiting portion 112. Surfaces that are of the two rows of first connection terminals 12 and that are in contact with the supporting member 11 include a surface (the first surface 1A) opposite to a surface (the second surface 1B) on which the base is in contact with the supporting member. The first embedding portion 132 and the second embedding portion 133 of the base are fastened in openings of the two rows of first connection terminals 12, and are not in contact with the two rows of first connection terminals 12. Refer to (b) in FIG. 9. The second embedding portion 133 is fastened in the opening of the first connection terminal 12. Similarly, the first embedding portion is also fastened in the opening of the first connection terminal 12. A reverse terminal design is used, so that the base 13 can be embedded into the supporting member 11, and a connection between the base 13 and the supporting member 11 is strengthened. In addition, a height of the connector male plug 1 can further decrease, and product competitiveness in terms of thinness is further improved.

It may be understood that the base 13 fastens the first limiting portions 112 and the second limiting portions 113 on the supporting member 11, so that the base 13 fastens the two rows of first connection terminals 12.

FIG. 9 is an A-A stepped sectional view of the connector male plug 1 in FIG. 3. (a) in FIG. 9 is a bottom view of the connector male plug 1 in FIG. 3. (b) in FIG. 9 is a stepped sectional view along an arrow A-A. A cutting plane on the right in (b) in FIG. 9 passes through the supporting member 11, the first connection terminal 12, and the base 13. Specifically, the third embedding portion 121 is fastened to the interior of the first through hole 131 through the fifth embedding portion 1151. Profiling relief is performed on a tail portion (namely, the third embedding portion 121) of the first connection terminal, to avoid contact with the base 13, and improve strength and safety performance of the components in a thinner structure.

Refer to FIG. 3. A first protrusion portion 116 exists between every two first limiting portions 112, and a first protrusion portion 117 exists between every two second limiting portions 113. A cutting plane on the left in (b) in FIG. 9 passes through the first protrusion portion 116 of the supporting member 11, the main body of the base 13, and the second embedding portion 133, and the cutting plane does not pass through the first through hole 131 of the base 13. A cutting plane on the right in (b) in FIG. 9 passes through the supporting member 11, the first connection terminal 12, and the first embedding portion 132 of the base 13. It can be learned from (b) in FIG. 9 that the first embedding portion 132 and the second embedding portion 133 are fastened to the supporting member 11, and are hidden in the supporting member 11. For example, on the basis of fastening the base 13, the supporting member 11 may be obtained through an injection molding process, so that a groove suitable for the first embedding portion 132 and the second embedding portion 133 is formed inside the supporting member 11. For example, refer to FIG. 7(a) to FIG. 7(c). The base 13 may further include a positioning portion, for example, a fifth through hole 135. The fifth through hole 135 is configured to fasten the base 13 when the supporting member 11 is manufactured.

In addition, refer to FIG. 4. To improve structural strength of the connector male plug 1, a male plug end fitting 14 may be further disposed at each of the first end 1a and the second end 1b of the connector male plug 1. The male plug end fitting 14 is fastened to the mounting portion 118 of the supporting member 11. (b) in FIG. 6 is a diagram of a structure of the male plug end fitting 14 in the connector male plug 1 in FIG. 3. The male plug end fitting 14 may be configured to improve structural stability of the connector male plug 1, and protect the first connection terminal 12. For example, the male plug end fitting 14 may alternatively be used as an electrode terminal of the connector male plug 1. The male plug end fitting 14 may be but is not limited to a deep drawn shell structure formed through a deep drawing process. The deep drawn shell structure may be integrally formed, or may be formed by soldering the parts.

Refer to FIG. 4. Materials of the first connection terminal 12 and the male plug end fitting 14 of the connector male plug 1 may be but are not limited to metal with high hardness, such as iron or steel.

After the connector male plug 1 provided in this application is described, the following describes a connector female receptacle 2 provided in this application.

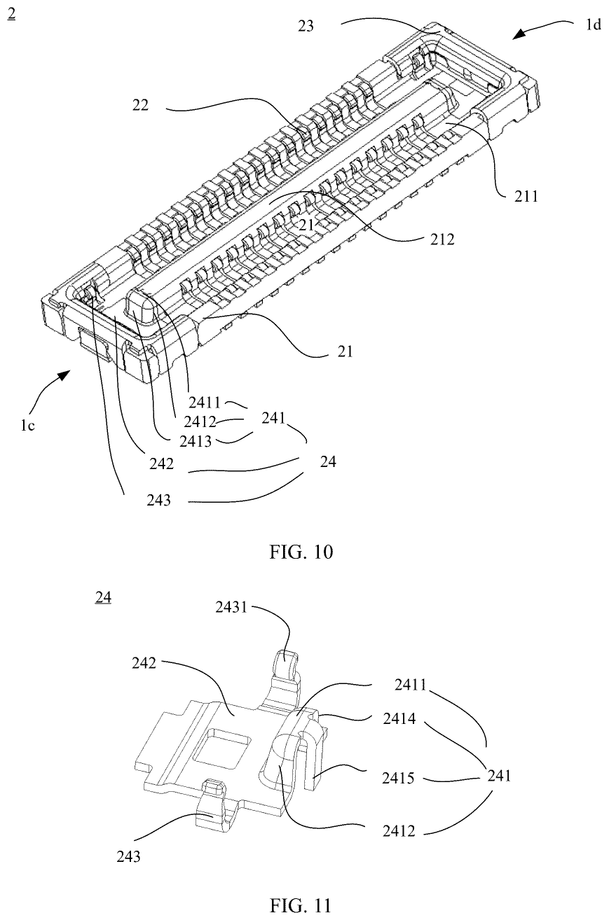

FIG. 10 is a diagram of a structure of the connector female receptacle 2 according to an embodiment of this application. The connector female receptacle 2 has a first end 1c and a second end 1d that are opposite to each other. The connector female receptacle 2 includes a first housing 21 and two rows of second connection terminals 22. The first housing 21 includes an accommodating cavity 211 and a middle island 212. The middle island 212 is a protrusion structure disposed on a bottom wall of the accommodating cavity 211, and the middle island 212 extends in a direction from the first end 1c to the second end 1d. The two rows of second connection terminals 22 are fastened to the first housing 21, and are respectively located on two sides of the middle island 212. Each row of second connection terminals 22 are arranged along an extension direction of the supporting portion. It may be understood that, after a male plug and a female receptacle of a conventional BTB connector are assembled, middle plastic of the connector male plug and middle island plastic of the connector female receptacle are in stop position. Therefore, a thickness of the middle island plastic of the connector female receptacle affects a height of the connector. A height of the middle island 212 of the connector female receptacle 2 provided in this application is less than or equal to 0.44 mm, and is lower than a height of a middle island of a conventional connector female receptacle. The height of the middle island of the connector female receptacle decreases, so that the height of the connector further decreases, and competitiveness of the BTB connector in terms of thinness is improved. For example, a height of the connector female receptacle 2 is less than or equal to 0.5 mm.

In addition, refer to FIG. 10. To improve structural strength of the connector female receptacle 2, a female receptacle end fitting 23 may be further disposed at each of the first end 1c and the second end 1d of the connector female receptacle 2. The female receptacle end fitting 23 may be configured to improve structural stability of the connector female receptacle 2, and protect the second connection terminals 22. For example, the female receptacle end fitting 23 may be further used as an electrode terminal of the connector female receptacle 2, to be electrically connected to an electrode terminal (the male plug end fitting 14) of the connector male plug 1, to implement current flowing between the electrode terminals. The female receptacle end fitting 23 may be but is not limited to a deep drawn shell structure formed through a drawing process. The deep drawn shell structure may be integrally formed, or may be formed by soldering the parts.

The connector female receptacle 2 further includes middle island fittings 24. FIG. 11 is a diagram of a structure of the middle island fitting 24 according to an embodiment of this application. When the middle island fitting 24 is specifically disposed, the middle island fitting 14 may be made of, but is not limited to, a material with high hardness, such as iron or steel. Refer to FIG. 10 and FIG. 11. The middle island fittings 24 are respectively disposed at two ends of the middle island 212. The middle island fitting 24 includes a fastened first supporting end 241, a fastened second supporting end 242, and an elastic arm 243. The first supporting end 241 covers each surface of an end portion of the middle island 212, and the elastic arm 243 is connected to the first supporting end 241 through the second supporting end 242. There are two elastic arms 243, and the two elastic arms 243 are respectively disposed on two opposite sides of the first supporting end 241. The elastic arms 243 have contact points 2431, and the contact points 2431 of the two elastic arms 243 are disposed opposite to each other.

Refer to FIG. 10 and FIG. 11. The first supporting end 241 of the middle island fitting 24 includes an end side surface 2411, a peripheral side surface 2412, a peripheral side surface 2415, and a peripheral side surface 2414. The peripheral side surface 2412 and the peripheral side surface 2414 are located on a same side of the end side surface 2411 and are opposite to each other. In addition, the peripheral side surface 2412 and the peripheral side surface 2414 are respectively connected to two opposite edges of the end side surface 2411. The peripheral side surface 2415 is located on the same side of the end side surface 2411 as the peripheral side surface 2412 and the peripheral side surface 2414, and is connected to an edge that is of the end side surface 2411 and that is located between the peripheral side surface 2412 and the peripheral side surface 2414. In a possible embodiment of this application, the peripheral side surface 2412, the peripheral side surface 2415, and the peripheral side surface 2414 may all be perpendicular to the end side surface 2411.

In addition, the second supporting end 242 and the peripheral side surface 2415 are located on two sides of the end side surface 2411, and the second supporting end 242 is connected to an end that is of the end side surface 2411 and that is opposite to the peripheral side surface 2415. In addition, a plane on which an extension direction of the second supporting end 242 is located may be parallel to a plane on which the peripheral side surface 2415 is located.

In some embodiments of this application, the middle island fitting 24 may further include the elastic arms 243, and the elastic arms 243 and the first supporting end 241 are located on a same side of the second supporting end 242, the elastic arms 243 are connected to the first supporting end 241 through the second supporting end 242. When the elastic arm 243 is specifically disposed, still refer to FIG. 11. There may be two elastic arms 243, and the two elastic arms 243 are disposed opposite to each other. In addition, the two elastic arms 243 are respectively disposed on two sides of the first supporting end 241 and the second supporting end 242. In a possible embodiment, the elastic arm 243 may be a bending structure formed by bending the second supporting end 242, to simplify a processing process of the elastic arm 243.

Still refer to FIG. 11. One contact point 2431 is disposed on each of the two elastic arms 243, and the contact points 2431 of the two elastic arms 243 are disposed opposite to each other, so that the middle island fitting 24 is used as an electrode terminal of the connector female receptacle 2. In the embodiment shown in (b) a in FIG. 11, the contact point 2431 may be a bending structure formed by bending an end portion that is of the elastic arm 243 and that is away from the second supporting end 242. The contact point 2431 of the elastic arm 243 is formed in a bending manner, so that a structure of the elastic arm 243 can be effectively simplified, to help improve manufacturing efficiency of the middle island fitting 24 provided with the elastic arm 243. In addition, in the embodiment shown in FIG. 11, the contact point 2431 is a protrusion disposed at the end portion that is of the elastic arm 243 and that is away from the second supporting end 242. It may be understood that the foregoing manner of disposing the elastic arm 243 is merely some example descriptions provided in this application. In some possible embodiments of this application, the elastic arm 243 may alternatively use another possible structure, which is not listed one by one herein.

After the connector male plug 1 and the connector female receptacle 2 provided in this application is described, the following describes the connector provided in this application.

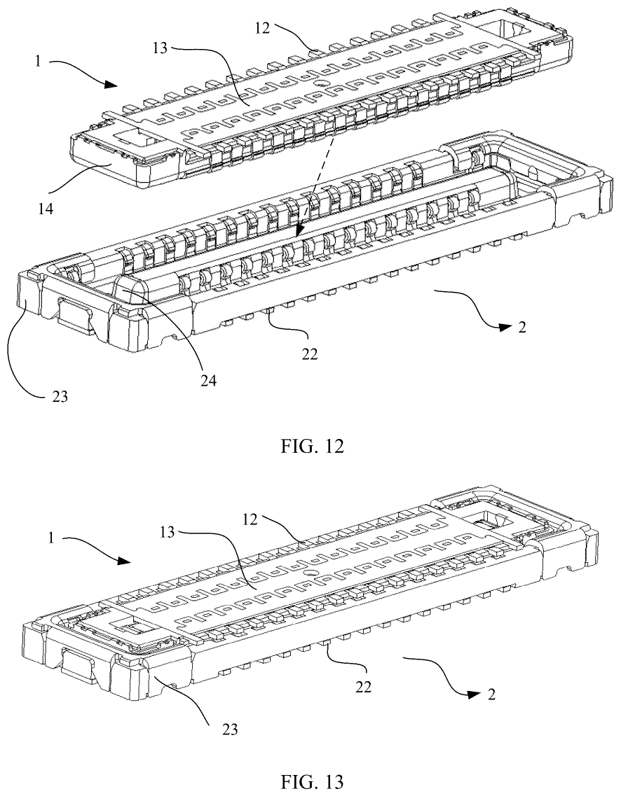

When the connector male plug 1 is plugged into the connector female receptacle 2, refer to FIG. 12 and FIG. 13. The supporting member 11 of the connector male plug 1 is inserted into the accommodating cavity of the connector female receptacle 2. In addition, the connection terminals 12 of the connector male plug 1 are in one-to-one conductive contact with the connection terminals 22 of the connector female receptacle. Specifically, one row of first connection terminals 12 are in one-to-one conductive contact with one row of second connection terminals 22 that are in the two rows of second connection terminals 22 and that are disposed on a same side as the row of first connection terminals 12, and the other row of first connection terminals 12 are in one-to-one conductive contact with the other row of second connection terminals 22 that are in the two rows of second connection terminals 22 and that are disposed on a same side as the other row of first connection terminals 12. In a plugging process, acting force that is applied to the connector female receptacle 2 and that has a large included angle with a plugging direction can be reduced, to avoid damage to the first connection terminal 12.

In addition, in the foregoing plugging process, the base 13 in the connector male plug 1 can improve strength of a main body of the connector male plug 1. The middle island fitting 24 of the connector female receptacle 2 can support the connector male plug 1, to avoid a phenomenon such as tilting of a part that is of the second connection terminals 22 of the connector female receptacle 2 and that is hidden in the middle island 212.

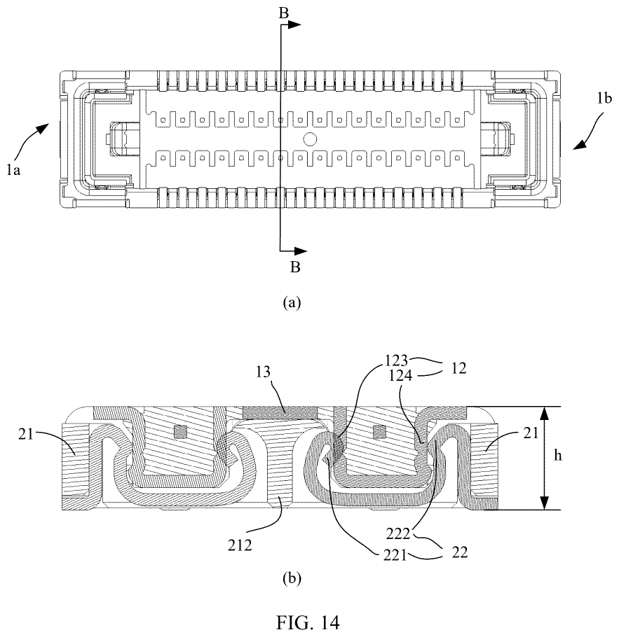

A connector obtained by assembly or plugging of the connector male plug 1 and the connector female receptacle 2 is shown in FIG. 13. FIG. 14 is a B-B sectional view of the connector in FIG. 13. (a) in FIG. 14 is a top view of the connector in FIG. 13. (b) in FIG. 14 is a sectional view along an arrow B-B.

It can be learned from (b) in FIG. 14 that the top surface of the base 13 is flush with the top surface of the connector female receptacle 2, and the bottom of the middle island 212 is close to the bottom of the pin of the second connection terminal 22. Therefore, a height of the connector female receptacle 2 determines a height of the connector provided in this application. Because the height of the connector female receptacle 2 in this application is less than or equal to 0.5 mm, the height of the connector is less than or equal to 0.5 mm, and a sum of a thickness of the base 13 and a height of the middle island 212 is also less than or equal to 0.5 mm. In addition, as described above, the thickness of the base 13 is less than or equal to 0.11 mm, and the height of the middle island 212 is less than or equal to 0.44 mm.

Refer to (b) in FIG. 14. A first contact portion 123 of the first connection terminal 12 and a second contact portion 221 of the second connection terminal 22 are in contact with each other, and a third contact portion 124 of the first connection terminal 12 and a fourth contact portion 222 of the second connection terminal 22 are in contact with each other. The first contact portion 123 is disposed opposite to the third contact portion 124, and the second contact portion 221 is disposed opposite to the fourth contact portion 222.

When assembling or plugging of the connector male plug 1 and the connector female receptacle 2 is started, a contact point at which the first contact portion 123 and the second contact portion 221 are in contact with each other is a first contact point. When assembling or plugging of the connector male plug 1 and the connector female receptacle 2 is completed, a contact point at which the first contact portion 123 and the second contact portion 221 are in contact with each other is a second contact point. A distance between the first contact point and the second contact point is greater than or equal to a first threshold. The first threshold is greater than or equal to 0.1 mm. Similarly, when assembling or plugging of the connector male plug 1 and the connector female receptacle 2 is started, a contact point at which the third contact portion 124 and the fourth contact portion 222 are in contact with each other is a third contact point. When assembling or plugging of the connector male plug 1 and the connector female receptacle 2 is completed, a contact point at which the third contact portion 124 and the fourth contact portion 222 are in contact with each other is a fourth contact point. A distance between the third contact point and the fourth contact point is greater than or equal to the first threshold. The first threshold is greater than or equal to 0.1 mm. In this way, in a process of assembling or plugging the connector male plug 1 and the connector female receptacle 2, a sliding distance between the first connection terminal 12 and the second connection terminal 22 is ensured, and poor contact such as false mating and floating height between the first connection terminal 12 and the second connection terminal 22 is reduced. This reduces a risk of poor contact of the BTB connector.

Refer to FIG. 13. When the connector including the connector male plug 1 and the connector female receptacle 2 in the foregoing embodiment is used for connecting two functional modules, the connector female receptacle 2 may be electrically connected to a circuit board of one of the functional modules through the pin of the second connection terminal 22, and the connector male plug 1 is electrically connected to a circuit board of the other functional module through the first connection terminal 12. Because the connector female receptacle 2 and the connector male plug 1 of the connector provided in this application have good structural stability, when the connector male plug 1 is plugged into the connector female receptacle 2, the first connection terminals 12 and the second connection terminals 22 at corresponding positions in the connector female receptacle 2 and the connector male plug 1 can be in reliable contact. In this way, an effective connection between the two functional modules can be implemented.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A connector male plug, comprising:
a base comprising a connection portion and a main body, wherein the connection portion comprises at least one limiting hole;
a supporting member fastened to the connection portion, wherein the supporting member comprises at least one limiting portion, the at least one limiting portion fits with the at least one limiting hole, and a material of the base has a higher strength than a material of the supporting member; and
two rows of first connection terminals fastened to the supporting member.

2. The connector male plug according to claim 1, wherein:
the material of the base is metal or ceramic; and
the material of the supporting member is plastic.

3. The connector male plug according to claim 1, wherein:
the base further comprises an embedding portion, wherein the embedding portion is a bending structure that is connected to the main body of the base and faces the supporting member; and
the embedding portion is fastened to the supporting member and is partially or completely hidden in the supporting member.

4. The connector male plug according to claim 1, wherein:
the base further comprises an embedding portion;
the connector male plug has a first end and a second end; and
the embedding portion extends in a direction from the first end to the second end, and a bending reference line of the embedding portion passes through or does not pass through all or some of the at least one limiting hole.

5. The connector male plug according to claim 1, wherein:
the supporting member further comprises a row of first limiting portions and a row of second limiting portions that are disposed opposite to each other; and
a first row of the two rows of first connection terminals is fastened to the row of first limiting portions, and a second row of the two rows of first connection terminals is fastened to the row of second limiting portions.

6. The connector male plug according to claim 1, wherein:
each first connection terminal in the two rows of first connection terminals comprises two ends;
a first end of the two ends is embedded in the limiting hole; and
a second end of the two ends is a first pin configured to electrically connect to another circuit.

7. The connector male plug according to claim 1, wherein:
the base further comprises an embedding portion;
a main body of each first connection terminal has a U-shaped structure, and an opening of the U-shaped structure faces the supporting member;
surfaces of the two rows of first connection terminals that are in contact with the supporting member comprise a surface opposite to a first surface, wherein the first surface is a surface on which the base is in contact with the supporting member; and
the embedding portion of the base is fastened in openings of the two rows of first connection terminals and is not in contact with the two rows of first connection terminals.

8. The connector male plug according to claim 1, wherein:
the supporting member has an annular structure, and two ends of the annular structure further comprise mounting portions that are disposed opposite to each other; and
the connector male plug further comprises male plug end fittings fastened to the mounting portions.

9. The connector male plug according to claim 1, wherein the base further comprises a positioning portion configured to position the base when the connector male plug is manufactured.

10. A connector, comprising:
a connector male plug comprising:
a base comprising a connection portion and a main body, wherein the connection portion comprises at least one limiting hole,
a supporting member fastened to the connection portion, wherein the supporting member comprises at least one limiting portion, the at least one limiting portion fits with the at least one limiting hole, and a material of the base has a higher strength than a material of the supporting member, and
two rows of first connection terminals fastened to the supporting member; and
a connector female receptacle comprising:
a first housing comprising an accommodating cavity and a middle island, wherein the middle island is a protrusion structure disposed on a bottom wall of the accommodating cavity and extends in a second direction, and
two rows of second connection terminals fastened to the first housing and respectively located on two sides of the middle island, wherein the two rows of second connection terminals are arranged in the second direction, wherein:
the supporting member of the connector male plug is plugged into the accommodating cavity of the first housing of the connector female receptacle,
one row of the two rows of first connection terminals is in one-to-one conductive contact with one row of the two rows of second connection terminals disposed on a same side as a first row of first connection terminals, and
a second row of the two rows of first connection terminals is in one-to-one conductive contact with a row of the two rows of second connection terminals disposed on a same side as the second row of first connection terminals.

11. The connector according to claim 10, wherein:
a first contact portion of each first connection terminal and a second contact portion of each second connection terminal are in contact with each other;
a third contact portion of each first connection terminal and a fourth contact portion of each second connection terminal are in contact with each other;
the first contact portion is disposed opposite to the third contact portion;
the second contact portion is disposed opposite to the fourth contact portion;
the first contact portion and the second contact portion are configured, such that, at a start of an assembly of the connector male plug and the connector female receptacle, a contact point at which the first contact portion and the second contact portion are in contact with each other is a first contact point;
the first contact portion and the second contact portion are further configured, such that, at a completion of the assembly of the connector male plug and the connector female receptacle, a contact point at which the first contact portion and the second contact portion are in contact with each other is a second contact point; and
a distance between the first contact point and the second contact point is greater than or equal to a first threshold.

12. The connector according to claim 10, wherein the connector female receptacle further comprises a middle island fitting disposed at an end portion of the middle island, the middle island fitting comprising:
a fastened first supporting end;
a fastened second supporting end; and
two elastic arms, wherein:
the first supporting end covers each surface of the end portion of the middle island,
the two elastic arms are connected to the first supporting end through the second supporting end and are respectively disposed on two opposite sides of the first supporting end, and
the two elastic arms have contact points disposed opposite to each other.

13. The connector according to claim 10, wherein:
the material of the base is metal or ceramic; and
the material of the supporting member is plastic.

14. The connector according to claim 10, wherein:
the base further comprises an embedding portion, wherein the embedding portion is a bending structure that is connected to the main body of the base and faces the supporting member; and
the embedding portion is fastened to the supporting member and is partially or completely hidden in the supporting member.

15. The connector according to claim 10, wherein:
the base further comprises an embedding portion;
the connector male plug has a first end and a second end; and
the embedding portion extends in a direction from the first end to the second end, and a bending reference line of the embedding portion passes through or does not pass through all or some of the at least one limiting hole.

16. The connector according to claim 10, wherein:
the supporting member further comprises a row of first limiting portions and a row of second limiting portions that are disposed opposite to each other; and
a first row of the two rows of first connection terminals is fastened to the row of first limiting portions, and a second row of the two rows of first connection terminals is fastened to the row of second limiting portions.

17. The connector according to claim 10, wherein:
each first connection terminal in the two rows of first connection terminals comprises two ends;
a first end of the two ends is embedded in the limiting hole; and
a second end of the two ends is a first pin configured to electrically connect to another circuit.

18. The connector according to claim 10, wherein:
the base further comprises an embedding portion;
a main body of each first connection terminal has a U-shaped structure, and an opening of the U-shaped structure faces the supporting member;
surfaces of the two rows of first connection terminals that are in contact with the supporting member comprise a surface opposite to a first surface, wherein the first surface is a surface on which the base is in contact with the supporting member; and
the embedding portion of the base is fastened in openings of the two rows of first connection terminals and is not in contact with the two rows of first connection terminals.

19. The connector according to claim 10, wherein:
the supporting member has an annular structure, and two ends of the annular structure further comprise mounting portions that are disposed opposite to each other; and
the connector male plug further comprises male plug end fittings fastened to the mounting portions.

20. An electronic device, comprising:
a first circuit board;
a second circuit board; and
a connector comprising:
a connector male plug comprising:
a base comprising a connection portion and a main body, wherein the connection portion comprises at least one limiting hole,
a supporting member fastened to the connection portion, wherein the supporting member comprises at least one limiting portion, the at least one limiting portion fits with the at least one limiting hole, and a material of the base has a higher strength than a material of the supporting member, and
two rows of first connection terminals fastened to the supporting member; and
a connector female receptacle comprising:
a first housing comprising an accommodating cavity and a middle island, wherein the middle island is a protrusion structure disposed on a bottom wall of the accommodating cavity and extends in a second direction, and
two rows of second connection terminals fastened to the first housing and respectively located on two sides of the middle island, wherein:
the two rows of second connection terminals are arranged in the second direction,
the supporting member of the connector male plug is plugged into the accommodating cavity of the first housing of the connector female receptacle,
a first row of the two rows of first connection terminals is in one-to-one conductive contact with a first row of the two rows of second connection terminals disposed on a same side as the first row of first connection terminals,
a second row of the two rows of first connection terminals is in one-to-one conductive contact with a second row of the two rows of second connection terminals disposed on a same side as the second row of first connection terminals,
the connector male plug is electrically connected to the first circuit board through the first connection terminals and the base, and
the connector female receptacle is electrically connected to the second circuit board through the second connection terminals.
